(19) United States
(12) Patent Application Publication
(10) Pub. No.: US 2009/0039711 A1
(43) Pub. Date: Feb. 12, 2009

(54) Dual-Polarity Multi-Output DC/DC Converters and Voltage Regulators

(75) Inventor: Richard K. Williams, Fremont, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Sunnyvale, CA (US)

(21) Appl. No.: 11/835,809

(22) Filed: Aug. 8, 2007

(51) Int. Cl. G05F 1/44; H01H 19/00

(52) U.S. Cl. 307/113; 323/271

(57) ABSTRACT

A two-output dual polarity inductive boost converter includes an inductor, a first output node, a second output node, and a switching network, the switching network configured to provide the following modes of circuit operation: 1) a first mode where the positive electrode of the inductor is connected to an input voltage and the negative electrode of the inductor is connected to ground; 2) a second mode where the positive electrode of the inductor is connected to the first output node and the negative electrode of the inductor is connected to the second output node; and 3) a third mode where the positive electrode of the inductor is connected to the input voltage and the negative electrode of the inductor is connected to the second output node.

### BACKGROUND OF THE INVENTION

Voltage regulation is commonly required to prevent variation in the supply voltage powering various microelectronic components such as digital ICs, semiconductor memory, display modules, hard disk drives, RF circuitry, microprocessors, digital signal processors and analog ICs, especially in battery powered application likes cell phones, notebook computers and consumer products.

Since the battery or DC input voltage of a product often must be stepped-up to a higher DC voltage, or stepped-down to a lower DC voltage, such regulators are referred to as DC-to-DC converters. Step-down converters are used whenever a battery's voltage is greater than the desired load voltage. Step-down converters may comprise inductive switching regulators, capacitive charge pumps, and linear regulators. Conversely, step-up converters, commonly referred to boost converters, are needed whenever a battery's voltage is lower than the voltage needed to power its load. Step-up converters may comprise inductive switching regulators or capacitive charge pumps.

Of the aforementioned voltage regulators, the inductive switching converter can achieve superior performance over the widest range of currents, input voltages and output voltages. The fundamental principal of a DC/DC inductive switching converter is based on the simple premise that the current in an inductor (coil or transformer) cannot be changed instantly and that an inductor will produce an opposing voltage to resist any change in its current.

The basic principle of an inductor-based DC/DC switching converter is to switch or “chop” a DC supply into pulses or bursts, and to filter those bursts using a low-pass filter comprising and inductor and capacitor to produce a well behaved time varying voltage, i.e. to change DC into AC. By using one or more transistors switching at a high frequency to repeatedly magnetize and de-magnetize an inductor, the inductor can be used to step-up or step-down the converter's input, producing an output voltage different from its input. After changing the AC voltage up or down using magnetics, the output is then rectified back into DC, and filtered to remove any ripple.

The transistors are typically implemented using MOSFETs with a low on-state resistance, commonly referred to as “power MOSFETs”. Using feedback from the converter's output voltage to control the switching conditions, a constant well-regulated output voltage can be maintained despite rapid changes in the converter's input voltage or its output current.

To remove any AC noise or ripple generated by switching action of the transistors, an output capacitor is placed across the output of the switching regulator circuit. Together the inductor and the output capacitor form a “low-pass” filter able to remove the majority of the transistors' switching noise from reaching the load. The switching frequency, typically 1 MHz or more, must be “high” relative to the resonant frequency of the filter's “LC” tank. Averaged across multiple switching cycles, the switched inductor behaves like a programmable current source with a slow-changing average current.

Since the average inductor current is controlled by transistors that are either biased as “on” or “off” switches, then power dissipation in the transistors is theoretically small and high converter efficiencies, in the eighty to ninety percent range, can be realized. Specifically when a power MOSFET is biased as an on-state switch using a “high” gate bias, it exhibits a linear I-V drain characteristic with a low R_{DS}(on) resistance typically 200 milliohms or less. At 0.5 A for example, such a device will exhibit a maximum voltage drop I_{D·R}_{DS}(on) of only 100 mV despite its high drain current. Its power dissipation during its on-state conduction time is ID²·R_{DS}(on). In the example given the power dissipation during the transistor's conduction is (0.5 A)²·(0.2Ω)=50 mW.

In its off state, a power MOSFET has its gate biased to its source, i.e. so that V_{GS}=0. Even with an applied drain voltage V_{DS} equal to a converter's battery input voltage V_{batt}, a power MOSFET's drain current I_{DSS} is very small, typically well below one microampere and more generally nanoamperes. The current I_{DSS} primarily comprises junction leakage.

So a power MOSFET used as a switch in a DC/DC converter is efficient since in its off condition it exhibits low currents at high voltages, and in its on state it exhibits high currents at a low voltage drop. Excepting switching transients, the I_{D}·V_{DS} product in the power MOSFET remains small, and power dissipation in the switch remains low.

Power MOSFETs are not only used to convert AC into DC by chopping the input supply, but may also be used to replace the rectifier diodes needed to rectify the synthesized AC back into DC. Operation of a MOSFET as a rectifier often is accomplished by placing the MOSFET in parallel with a Schottky diode and turning on the MOSFET whenever the diode conducts, i.e. synchronous to the diode's conduction. In such an application, the MOSFET is therefore referred to as a synchronous rectifier.

Since the synchronous rectifier MOSFET can be sized to have a low on-resistance and a lower voltage drop than the Schottky, conduction current is diverted from the diode to the MOSFET channel and overall power dissipation in the “rectifier” is reduced. Most power MOSFETs includes a parasitic source-to-drain diode. In a switching regulator, the orientation of this intrinsic P-N diode must be the same polarity as the Schottky diode, i.e. cathode to cathode, anode to anode. Since the parallel combination of this silicon P-N diode and the Schottky diode only carry current for brief intervals known as “break-before-make” before the synchronous rectifier MOSFET turns on, the average power dissipation in the diodes is low and the Schottky oftentimes is eliminated altogether.

Assuming transistor switching events are relatively fast compared to the oscillating period, the power loss during switching can in circuit analysis be considered negligible or alternatively treated as a fixed power loss. Overall, then, the power lost in a low-voltage switching regulator can be estimated by considering the conduction and gate drive losses. At multi-megahertz switching frequencies, however, the switching waveform analysis becomes more significant and must be considered by analyzing a device's drain voltage, drain current, and gate bias voltage drive versus time.

Based on the above principles, present day inductor-based DC/DC switching regulators are implemented using a wide range of circuits, inductors, and converter topologies. Broadly they are divided into two major types of topologies, non-isolated and isolated converters.

The most common isolated converters include the flyback and the forward converter, and require a transformer or coupled inductor. At higher power, full bridge converters are also used. Isolated converters are able to step up or step down their input voltage by adjusting the primary to secondary winding ratio of the transformer. Transformers with multiple windings can produce multiple outputs simultaneously, including voltages both higher and lower than the input. The disadvantage of transformers is they are large compared to single-winding inductors and suffer from unwanted stray inductances.

Non-isolated power supplies include the step-down Buck converter, the step-up boost converter, and the Buck-boost converter. Buck and boost converters are especially efficient and compact in size, especially operating in the megahertz frequency range where inductors 2.2 pH or less may be used. Such topologies produce a single regulated output voltage per coil, and require a dedicated control loop and separate PWM controller for each output to constantly adjust switch on-times to regulate voltage.

In portable and battery powered applications, synchronous rectification is commonly employed to improve efficiency. A step-down Buck converter employing synchronous rectification is known as a synchronous Buck regulator. A step-up boost converter employing synchronous rectification is known as a synchronous boost converter.

Synchronous Boost Converter Operation: As illustrated in FIG. 1, prior art synchronous boost converter 1 includes a low-side power MOSFET switch 2, battery connected inductor 3, an output capacitor 6, and “floating” synchronous rectifier MOSFET 4 with parallel rectifier diode 5. The gates of the MOSFETs driven by break-before-make circuitry (not shown) and controlled by PWM controller 7 in response to voltage feedback V_{FB} from the converter's output present across filter capacitor 6. BBM operation is needed to prevent shorting out output capacitor 6.

The synchronous rectifier MOSFET 5, which may be N-channel or P-channel, is considered floating in the sense that its source and drain terminals are not permanently connected to any supply rail, i.e. neither to ground or V_{batt}. Diode 5 is a P-N diode intrinsic to synchronous rectifier MOSFET 4, regardless whether synchronous rectifier is a P-channel or an N-channel device. A Schottky diode may be included in parallel with MOSFET 4 but with series inductance may not operate fast enough to divert current from forward biasing intrinsic diode 5. Diode 8 comprises a P-N junction diode intrinsic to N-channel low-side MOSFET 2 and remains reverse biased under normal boost converter operation. Since diode 8 does not conduct under normal boost operation, it is shown as dotted lines.

If we define the converter's duty factor D as the time that energy flows from the battery or power source into the DC/DC converter, i.e. during the time that low-side MOSFET switch 2 is on and inductor 3 is being magnetized, then the output to input voltage ratio of a boost converter is proportionate to the inverse of 1 minus its duty factor, i.e.

$$\frac{{V}_{out}}{{V}_{i n}} = \frac{1}{1 - D} ≡ \frac{1}{1 - {t}_{sw} / T}$$

While this equation describes a wide range of conversion ratios, the boost converter cannot smoothly approach a unity transfer characteristic without requiring extremely fast devices and circuit response times. For high duty factors and conversion ratios, the inductor conducts large spikes of current and degrades efficiency. Considering these factors, boost converter duty factors are practically limited to the range of 5% to 75%.

The Need for Dual Polarity Regulated Voltages: Today's electronic devices require a large number of regulated voltages to operate, some of which may be negative with respect to ground. Some smart phones may use more than twenty-five separate regulated supplies in a single handheld, including negative bias supply needed for some organic light emitting diode, or OLED, displays. Space limitations preclude the use of so many switching regulators each with separate inductors.

Unfortunately, multiple output non-isolated converters capable of generating both positive and negative supply voltage require multiple winding or tapped inductors. While smaller than isolated converters and transformers, tapped inductors are also substantially larger and taller in height than single winding inductors, and suffer from increased parasitic effects and radiated noise. As a result multiple winding inductors are typically not employed in any space sensitive or portable device such as handsets and portable consumer electronics.

As a compromise, today's portable devices employ only a few switching regulators in combination with a number of linear regulators to produce the requisite number of independent supply voltages. While the efficiency of the low-drop-out linear regulators, or LDOs, is often worse than the switching regulators, they are much smaller and lower in cost since no coil is required. As a result efficiency and battery life is sacrificed for lower cost and smaller size. Negative supply voltages require a dedicated switching regulator that cannot be shared with positive voltage regulators.

What is needed is a switching regulator implementation capable of producing both positive and negative outputs, i.e. dual polarity outputs, from a single winding inductor, minimizing both cost and size.

### SUMMARY OF THE INVENTION

This disclosure describes an inventive boost converter able to produce two independently-regulated outputs of opposite polarity, i.e. one positive above-ground output and one negative below-ground output from one single-winding inductor. A representative implementation of the two-output dual polarity inductive boost converter includes an inductor, a first output node, a second output node, and a switching network, the switching network configured to provide the following modes of circuit operation: 1) a first mode where the positive electrode of the inductor is connected to an input voltage and the negative electrode of the inductor is connected to ground; 2) a second mode where the positive electrode of the inductor is connected to the first output node and the negative electrode of the inductor is connected to the second output node; and 3) a third mode where the positive electrode of the inductor is connected to the input voltage and the negative electrode of the inductor is connected to the second output node.

The first mode of operation charges the inductor to a voltage equal to the input voltage. The second mode of operation simultaneously transfers charge to the first and second output nodes. Once the first output node reaches a target voltage, the second mode ends. The third mode of operation continues charging the second output node until it reaches its target voltage. In this way, the boost converter provides two regulated outputs from a single inductor.

For a second embodiment, the same basic components are used. In this case, however, the switching network provides the following modes of operation: 1) a first mode where the positive electrode of the inductor is connected to an input voltage and the negative electrode of the inductor is connected to ground; 2) a second mode where the positive electrode of the inductor is connected to the input voltage and the negative electrode of the inductor is connected to the second output node; and 3) a third mode where the positive electrode of the inductor is connected to the first output node and the negative electrode of the inductor is connected to ground.

The first mode of operation charges the inductor to a voltage equal to the input voltage. The second mode of operation transfers charge to the first output node and ends when first output node reaches a target voltage. The third mode of operation transfers charge to the second output node and ends when second output node reaches its target voltage. In this way, the boost converter provides two regulated outputs from a single inductor.

### BRIEF DESCRIPTION OF THE DRAWINGS

FIG. 1 is a schematic of a prior art single output synchronous boost converter.

FIG. 2 is a schematic of a dual-polarity dual-output synchronous boost converter as provided by the present invention.

FIGS. 3A-3B show the boost converter of FIG. 2 performing an operational sequence that implements a mode referred to as synchronous transfer. Synchronous transfer mode includes the following successive operational phases: the inductor is magnetized (3A), charge is synchronously transferred to both +V_{OUT1} and to −V_{OUT2}, (3B) charge continues to be transferred exclusively to +V_{OUT1} (3C).

FIG. 4 is a plot of switching-waveforms characteristic of the boost converter of FIG. 2 operating in synchronous transfer mode.

FIG. 5 shows an alternative operational phase for the boost converter of FIG. 2 transferring charge exclusively to −V_{OUT2}.

FIG. 6 is a flowchart for the boost converter of FIG. 2 using synchronous transfer mode.

FIGS. 7A-7B show the boost converter of FIG. 2 performing an operational sequence that implements a mode referred to as time-multiplexed transfer. Time-multiplexed transfer mode includes the following successive operational phases: the inductor is magnetized (7A), charge is transferred exclusively to +V_{OUT1} (7B), charge is transferred exclusively to +V_{OUT2}. (7C).

FIG. 8 is a flowchart showing an operating sequence of the boost converter of FIG. 2 operating in time-multiplexed transfer mode.

FIG. 9 is a block diagram showing the boost converter of FIG. 2 modified to use digital control with multiplexed feedback.

### DETAILED DESCRIPTION OF THE PREFERRED EMBODIMENTS

As described previously, conventional non-isolated switching regulators require one single-winding inductor and corresponding dedicated PWM controller for each regulated output voltage and polarity. In contrast, this disclosure describes an inventive boost converter able to produce two independently-regulated outputs of opposite polarity, i.e. one positive above-ground output and one negative below-ground output from one single-winding inductor.

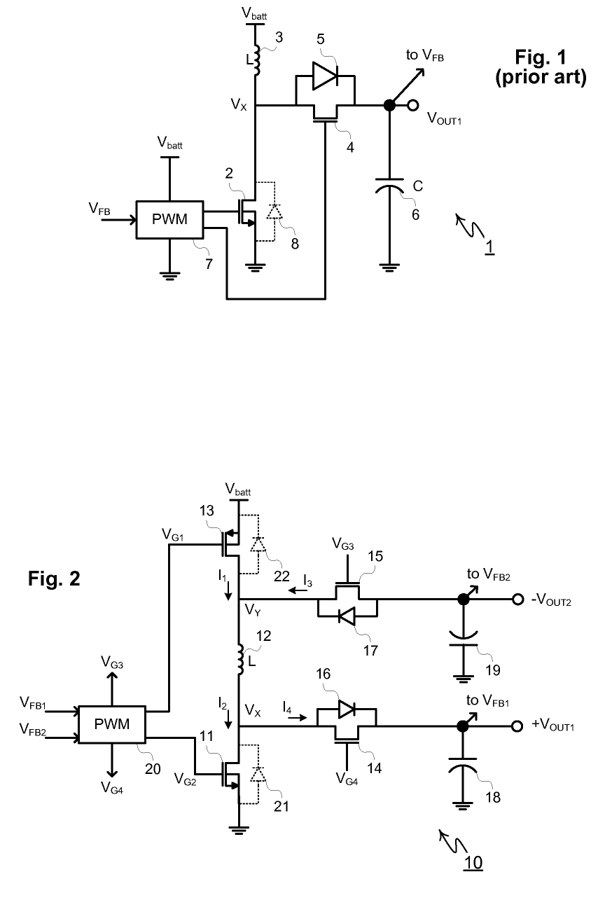

Shown in FIG. 2, a two-output dual polarity inductive boost converter 10 comprises low-side N-channel MOSFET 11, inductor 12, high-side P-channel MOSFET 13, floating positive-output synchronous rectifier 14 with intrinsic source-to-drain diode 16, floating negative-output synchronous rectifier 15 with intrinsic source-to-drain diode 17, output filter capacitors 18 and 19 filtering outputs +V_{OUT1} and −V_{OUT2}. Regulator operation is controlled by PWM-controller 20 including break-before-make gate buffer (not shown), which controls the on-time of MOSFETs 11, 13, 14 and 15. PWM controller 20 may operate at fixed or variable frequency.

Closed-loop regulation is achieved through feedback from the V_{OUT1}, and −V_{OUT2} outputs using corresponding feedback signals V_{FB1} and V_{FB2}. The feedback voltages may be scaled by resistor dividers (not shown) or other level shift circuitry as needed. Low-side MOSFET 11 includes intrinsic P-N diode 21 shown by dotted lines, which under normal operation remains reverse biased and non-conducting. Similarly, high-side MOSFET 13 includes intrinsic P-N diode 22 shown by dotted lines, which under normal operation remains reverse biased and non-conducting. High-side MOSFET 13 may be implemented using either P-channel or N-channel MOSFETs with appropriate adjustments in gate drive circuitry.

Unlike in conventional boost converters, in dual-polarity boost converter 10 magnetizing the inductor requires turning on both a high-side MOSFET 13 and a low-side MOSFET 11. Inductor 12 is therefore not hard-wired to either V_{batt} or to ground. As a result the inductor's terminal voltages at nodes Vₓ and V_{y} are not permanently fixed or limited to any given voltage potential except by forward biasing of intrinsic P-N diodes 21 and 22 and by the avalanche breakdown voltages of the devices employed.

Specifically, node V_{y} cannot exceed one forward-biased diode drop V_{f} above the battery input V_{batt} without forward biasing P-N diode 22 and being clamped to a voltage (V_{batt}+V_{f}). In the disclosed converter 10, inductor 12 cannot drive the V_{y} node voltage above V_{batt}, so that only switching noise can cause diode 22 to become forward biased.

Within the specified operating voltage range of the related devices, however, V_{y} can operate at voltages less positive than V_{batt} and can even operate at voltages below ground, i.e. V_{y} can operate at negative potentials.

The most negative V_{y} potential is limited by the BV_{DSS1} breakdown of the high-side MOSFET, a voltage corresponding to the reverse bias avalanche of intrinsic P-N diode 22. To avoid breakdown, the MOSFET's breakdown must exceed the maximum difference between V_{y}, which may be negative, and V_{batt}, i.e. BV_{DSS1}>(V_{batt}−V_{y}). The maximum operating voltage range of V_{y} is then bounded by the breakdown and forward biasing of diode 22 given by the relation

(V_{batt}+V_{f})>V_{y}>(V_{batt}−BV_{DSS1})

Similarly, node Vₓ cannot be biased beyond one forward-biased diode drop V_{f} below ground without forward biasing P-N diode 21 and being clamped to a voltage Vₓ=−V_{f}. In the disclosed converter 10, however, inductor 12 cannot drive the Vₓ node voltage below ground, so that only switching noise can cause diode 21 to become forward biased.

Within the specified operating voltage range of the related devices, however, Vₓ can operate at voltages above ground and typically operates at voltages more positive than V_{batt}. The most positive Vₓ potential is limited by the BV_{DSS2} breakdown of the low-side MOSFET, a voltage corresponding to the reverse bias avalanche of intrinsic P-N diode 21. To avoid breakdown, the MOSFET's BV_{DSS2} breakdown must the maximum of positive voltage of Vₓ, which should exceed V_{batt}, i.e. BV_{DSS2}>Vₓ. The maximum operating voltage range of Vₓ is then bounded by the breakdown and forward biasing of diode 21 given by the relation

BV_{DSS2}>Vₓ>(−V_{f})

With the V_{y} terminal of inductor 12 being able to operate at voltage below ground and the Vₓ terminal of inductor 12 being able to operate above V_{batt}, the circuit topology of disclosed dual-polarity boost converter 10 is significantly different than conventional boost converter 1 which can only operate above ground and has its inductor hard wired to its positive input voltage. Since inductor 12 is not hard-wired to any supply rail, the disclosed dual-polarity boost converter can therefore be considered a “floating inductor” switching converter. A conventional boost converter is not a floating inductor topology.

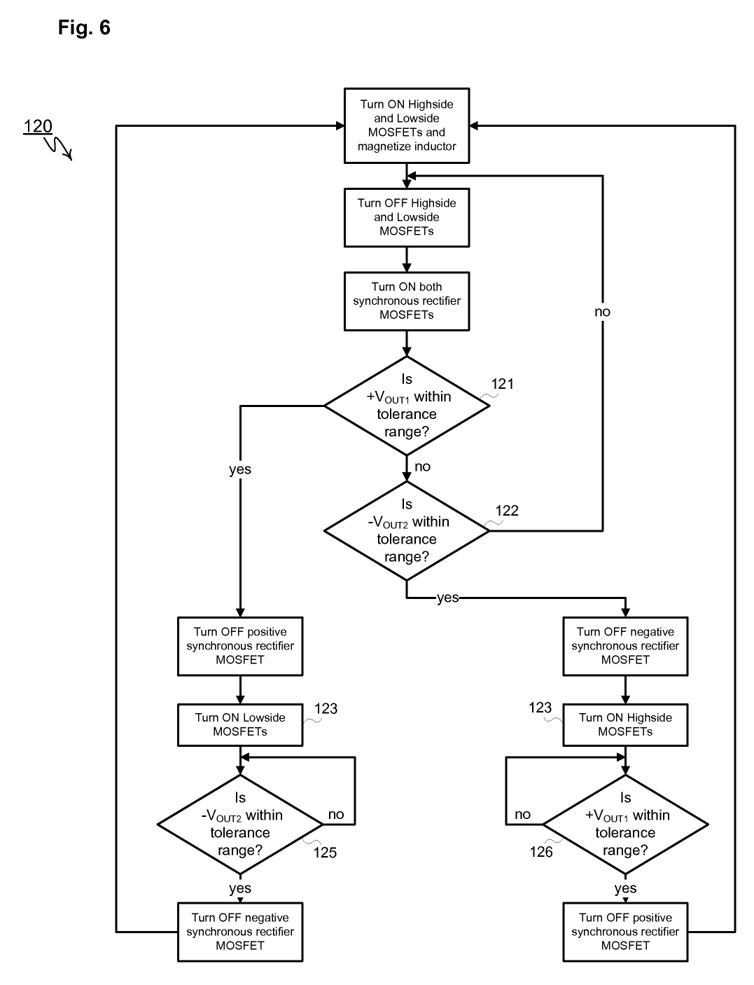

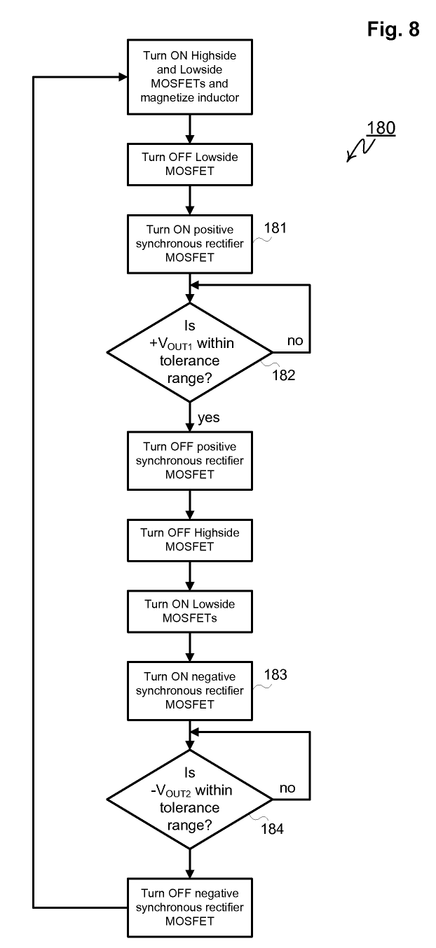

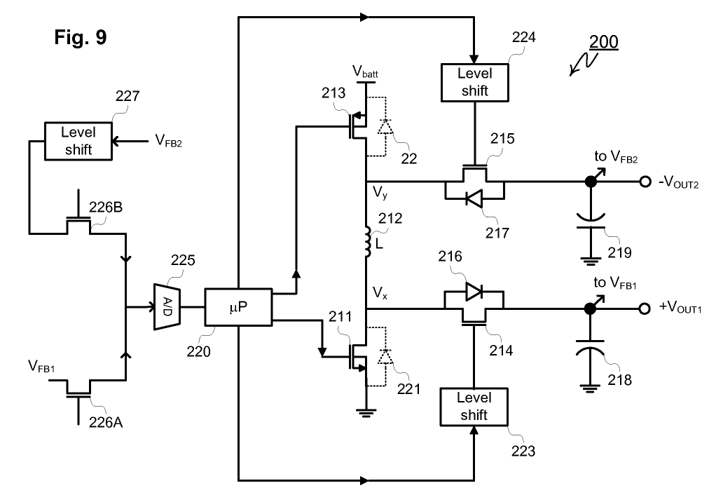

Operation of the disclosed dual-polarity boost converter involves alternating between magnetizing the inductor and then transferring energy to the outputs, before magnetizing the inductor again. Energy from the inductor may be transferred to both outputs simultaneously as describe in algorithm 120 in FIG. 6 or through time-multiplexing as illustrated in algorithm 180 in FIG. 8. Regardless of the algorithm employed, however, the first step in the operation of the disclosed dual-polarity boost converter is to store energy in, or herein to “magnetize”, the inductor, a process similar to charging a capacitor except the energy is stored in a magnetic rather an electric field.

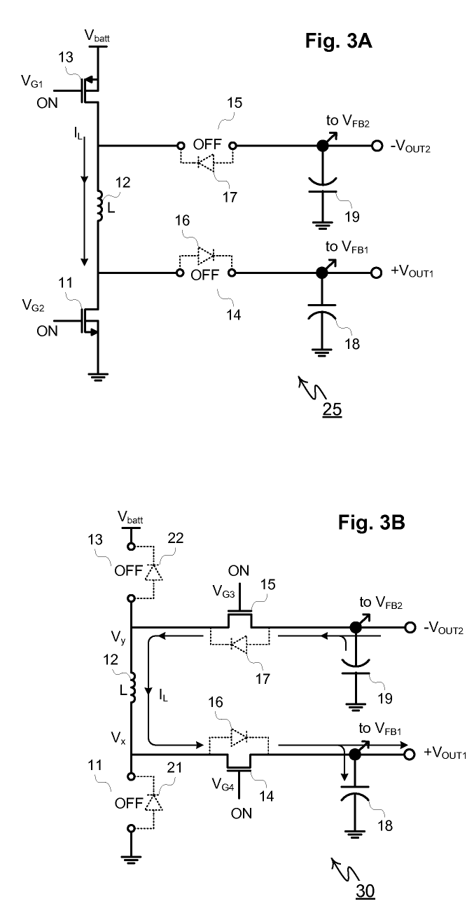

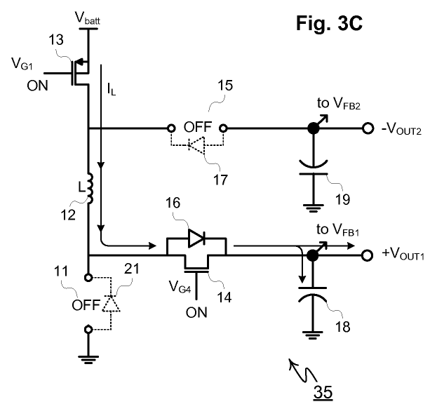

Inductor Magnetizing: FIG. 3A illustrates operation 25 of converter 10 during the magnetizing of inductor 12. Since inductor 12 is connected to battery input V_{batt} through not one, but two series connected MOSFETs, then both low-side and high-side MOSFETs 11 and 13 must be turned on simultaneously to allow current I_{L}(t) to ramp. Meanwhile synchronous rectifier MOSFETs 14 and 15 remain off and non-conducting. The current-voltage relationship for an inductor is given by the differential equation

$${V}_{L} = L \frac{d I}{d t}$$

which for small intervals can be approximated by the difference equation

$${V}_{L} ≅ L \frac{Δ I}{Δ t}$$

Assuming minimal voltage drop across on-state MOSFETs 11 and 13, then V_{L}≈V_{batt} and the above equation can be rearranged as

$$\frac{Δ I}{Δ t} = \frac{{V}_{L}}{L} \approx \frac{{V}_{batt}}{L}$$

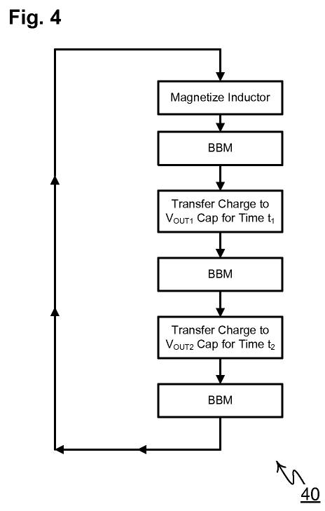

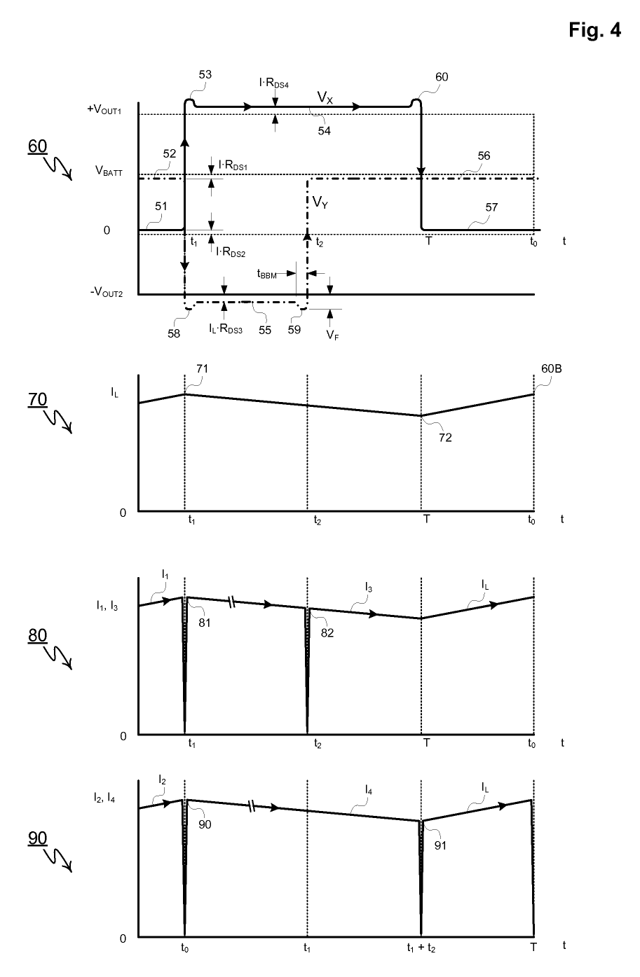

which describes for short magnetizing intervals the current I_{L}(t) in inductor 12 can be approximated as a linear ramp of current with time. For example as shown in graph 70 of FIG. 4, during the interval between to and t₁ the current I_{L} ramps linearly from some non-zero current at time to toward a peak value 71 at time t₁, the end of the magnetizing operating phase. The energy stored in inductor 12 at any time t is given by

$${E}_{L} ( t ) = \frac{{LI}^{2} ( t )}{2}$$

reaching its peak E_{L}(t₁)just before its current is interrupted by switching off one or both MOSFETs 11 and 13. As shown in graphs 70, 80 and 90 of FIG. 4, during magnetizing the current I₁ in low-side MOSFET 11 and the current I₂ in high-side MOSFET 13 are identical and equal to the inductor current I_{L} so that in the interval t₀ to t₁,

I₁(t)=I₂(t)=I_{L}(t)

At current I₂(t), a small voltage drop V_{DS2(on)} appears across series-connected low-side N-channel MOSFET 11. Operating in its linear region and carrying current I_{L}(t) with an on-state resistance of R_{DS2(on)} the voltage Vₓ is given by

Vₓ=V_{DS2(on)}=I_{L}·R_{DS2(on)}

as shown by line 51 in graph 50 of FIG. 4. For low on-resistances, typically a few hundred milliohms or less, then Vₓ is approximately equal to ground potential, i.e. Vₓ≈0. Similarly, a small voltage drop V_{DS1(on)} also appears across series-connected high-side P-channel MOSFET 13. Operating in its linear region at a current I_{L}(t) with an on-state resistance of R_{DS1(on)} the voltage V_{y} is then given by

V_{y}=V_{batt}−V_{DS1(on)}=V_{batt}−I_{L}·R_{DS1(on)}

as shown by line 52 in graph 50 of FIG. 4. For low on-resistances, then V_{y} is approximately equal to the battery potential, i.e. V_{y} V_{batt}.

Given that Vₓ≈0 and V_{y}≈V_{batt} then the approximation V_{L}=(V_{y}−Vₓ)≈V_{batt} is a valid assumption. Accordingly, the ramp in inductor current shown in graph 70 can, as described previously, therefore be approximated as a straight line segment with a slope (V_{batt}/L). Furthermore assuming the voltage +V_{OUT1} across capacitor 18 is above ground and the voltage −V_{OUT2} across capacitor 19 is below ground, then +V_{OUT1}>Vₓ and V_{y}>−V_{OUT2} so that P-N diodes 16 and 17 are both reverse biased and non-conducting.

Synchronous Energy Transfer to Dual Outputs: After magnetizing inductor 12, in the synchronous transfer algorithm 120 both low-side and high-side MOSFETs are turned off simultaneously, as shown at time t₁ in graph 50 of FIG. 4. Interrupting the I₁ current in high-side MOSFET 13 and the I₂ current in low-side MOSFET 11 causes the inductor's Vₓ terminal to fly up to a positive voltage 53 greater than V_{OUT1}, forward biasing diode 16, and transferring energy to a first voltage output +V_{OUT1}. It also causes the inductor's V_{y} terminal to fly down to a below-ground voltage 58 more negative than V_{OUT2}, forward biasing diode 17, and simultaneously transferring energy to a second voltage output −V_{OUT2}.

During the transition, break-before-make circuitry prevents synchronous rectifier MOSFETs 14 and 15 from turning on and momentarily shorting out filter capacitors 18 and 19. Without MOSFET conduction, diodes 16 and 17 carry the inductor current I_{L} and exhibit a forward-biased voltage-drop V_{f}. The instantaneous voltage on Vₓ is then equal to (V_{OUT1}+V_{f}). The instantaneous voltage on V_{y} is similarly equal to (−V_{OUT2}−V_{f}).

At time t₁ when I_{L} is at its peak, interruption of current I₁ in high-side MOSFET 13 causes the current to be redirected into the synchronous rectifier MOSFET and diode according to Kirchoff's current law, so at node V_{y}

$${\sum }_{node {V}_{y}} I = 0 = ( {I}_{L} + {I}_{1} + {I}_{3} )$$

where I₃ includes the current in diode 17 and any junction capacitance associated with off MOSFET 15. Referring to graph 80 in FIG. 4 since inductor current I_{L} cannot change instantly, its current is then rerouted from I₁ to I₃ as illustrated at point 81.

At the same instant, interruption of current I₂ in low-side MOSFET 11 causes current to be redirected into the synchronous rectifier diode and MOSFET whereby at node Vₓ

$${\sum }_{node {V}_{x}} I = 0 = ( {I}_{L} + {I}_{2} + {I}_{4} )$$

and where I₄ includes the current in diode 16 and any junction capacitance associated with off MOSFET 14. Referring to graph 80 in FIG. 4 since inductor current I_{L} cannot change instantly, its current is then rerouted from I₁ to I₃ as illustrated at point 81. The current “hand-off” between I₂ and I₄ at node Vₓ and from I₁ to I₃ at node V_{y} means that Vₓ and V_{y} behave independently, as unrelated circuits that share a common energy storage element, namely inductor 12. In other words, inductor 12 essentially decouples the voltage at nodes Vₓ and V_{y} allowing them to act independently during the time energy is transferred to the loads and to output capacitors 18 and 19.

As shown in circuit 30 of FIG. 3B, after the break-before-make time interval t_{BBM} the synchronous rectifier MOSFETs 14 and 15 turn-on and shunt current away from diodes 16 and 17. As the MOSFETs turn on, the voltage drop across the parallel combination of the synchronous rectifier and the P-N diode transitions from the forward biased diode drop V_{f} to the MOSFET's on-state voltage V_{DS(ON)}=I_{L}·R_{DS(on)}. This change is manifested in the voltages Vₓ and V_{y} shown by curves 54 and 55 in graph 50 respectively where

Vₓ=V_{OUT1}+I_{L}·R_{DS4(on)}

and

V_{y}=−V_{OUT2}+I_{L}·R_{DS3(on)}

During this energy transfer phase, the current in inductor 12 simultaneously charges both capacitor 18 and 19. In this manner, both positive and negative polarity outputs +V_{OUT1} and −V_{OUT2} are simultaneously charged from a single inductor. According to algorithm 120, the condition shown in schematic 30 should continue until one of the capacitors comes into a specified tolerance range. The tolerance range of the target voltage is determined by the controller in response to the feedback signals V_{FB1} and V_{FB2}. Using analog control, the PWM controller 20 includes an error amplifier, a ramp generator, and a comparator to determine when to shut off the synchronous rectifier. Using digital control, this decision can be made by logic or software according to algorithm 120.

Synchronous Energy Transfer to One Output: Depending on the load conditions either output may reach its target voltage first as shown by the conditional logic 121 and 122 in algorithm 120. Once either output reaches its specified output voltage, the converter is again reconfigured to discontinue charging of the fully charged output capacitor but continue charging the output capacitor not yet within the tolerance range its specified voltage target.

For example, if at a time t₂ the negative output −V_{OUT2} reaches its target voltage before +V_{OUT1}, then the first action is to turn off synchronous rectifier MOSFET 15, herein referred to as the “negative synchronous rectifier,” and disconnect capacitor 19 from over charging. Since ΔQ=C·ΔV, then the charge refreshed on each output capacitor during the charge transfer cycle is given by

$$Δ {V}_{OUT 2} = - \frac{Δ Q}{{C}_{2}} = - \frac{1}{{C}_{2}} {\int }_{{t}_{1}}^{{t}_{2}} {I}_{L} ( t ) \cdot d t$$

where C₂ is the capacitance of negative output filter capacitor 19.

The instant that synchronous rectifier is turned off and for the entire break-before-make interval 59 of duration t_{BBM}, P-N diode 17 must carry the full inductor current I_{L} and the inductor node voltage V_{y} returns to a value of (−V_{OUT2}−V_{f}). After BBM interval 59 is completed, high-side MOSFET 13 is turned-on in step 124 and V_{y} jumps to a voltage of V_{batt}−I_{L}·R_{DS1(on)} shown by line 56 in graph 50. During the hand-off at time t₂, inductor current I_{L} is diverted from I₃ to I₁ in the transition shown by point 82 in graph 80. Current I₄ however remains unchanged.

This condition is shown in circuit 35 of FIG. 3C where the current path of I_{L} flows from V_{batt} through conducting high-side MOSFET 13, inductor 12, and on-state positive synchronous rectifier 14 so that I_{L}=I₁=I₄. Capacitor 18 therefore continues to charge even though charging of capacitor 19 has stopped. With V_{y} biased near V_{batt} and −V_{OUT2} below ground P-N diode 17 remains reversed biased and non-conducting.

The operating phase of circuit 35 is maintained in accordance with algorithm 120 by conditional logic 126 which continues until +V_{OUT1} reaches its target voltage. Once +V_{OUT1} is at its target voltage, positive synchronous rectifier MOSFET 14 is turned off and for the break-before-make duration t_{BBM} 60, diode 16 carries the inductor current. During this interval Vₓ increases to a voltage V_{OUT1}+V_{f}.

Once however the BBM interval 60 is completed low-side MOSFET 11 is turned on, current is diverted from I₄ to I₂ as shown in graph 90 of FIG. 4 and inductor 12 begins a new cycle of being magnetized returning to the state shown in circuit 25. Having completed the cycle, the total time is described as the period T which will vary depending on load current. This period is determined by the magnetizing duration and the positive or negative charge transfer phases which ever is longer.

The charge transferred to capacitor 18 during the interval from t₁ to T is given by

$$Δ {V}_{OUT 1} = \frac{Δ Q}{{C}_{1}} = \frac{1}{{C}_{1}} {\int }_{{t}_{1}}^{T} {I}_{L} ( t ) \cdot d t$$

where C₁ is the capacitance of positive output filter capacitor 18.

The example given in FIG. 3C described a case where the negative output −V_{OUT2} reached its target voltage before the positive output +V_{OUT1}. Algorithm 120 illustrates the converter also accommodates the opposite scenario, i.e. when the positive voltage hits its point of regulation first. If the outcome of conditional 121 is “yes” then positive synchronous rectifier MOSFET 14 is turned off first, whereby for an interval T_{BBM} diode 16 continues to supply current to capacitor 18. In step 123, the low-side MOSFET is turned on, forcing Vₓ to a near ground potential, reverse biasing diode 16 and discontinuing the charging of capacitor 18.

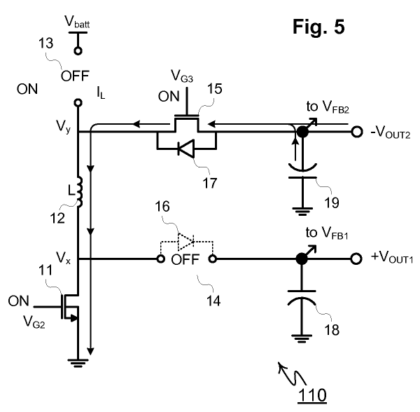

In the meantime negative synchronous rectifier MOSFET 15 continues to conduct charging −V_{OUT2} capacitor 19. This condition, illustrated in circuit 110 of FIG. 5 persists until conditional 125 in algorithm is satisfied in which case the negative synchronous rectifier 15 is turned off and after a BBM interval high-side MOSFET 13 is turned on forcing V_{y} near V_{batt}, reverse biasing diode 17 and discontinuing the charging of capacitor 19.

Voltage Regulation of the Dual-Polarity Floating-Inductor Regulator: Operation of the dual polarity boost converter requires turning on both high-side and low-side MOSFETs 13 and 11 to magnetize inductor 12 and then shutting off these MOSFETs to transfer energy to the converters outputs. In the synchronous energy transfer algorithm 120, both aforementioned high-side and low-side MOSFETs are shut off simultaneously starting the transfer of energy from the inductor to both outputs simultaneously.

Despite being charged synchronously, independent regulation of the positive and negative outputs are determined by the duration of energy transfer to each output. Specifically, by controlling the off-time of the low-side and high-side MOSFETs 11 and 14 through feedback V_{FB1} and V_{FB2}, the positive and negative output voltages +V_{OUT1} and −V_{OUT2} may be independently regulated from a single inductor 12.

The on-time of synchronous rectifiers 14 and 15, while affecting the converter's efficiency, do not determine the charging time of the output capacitors. For example, whenever the positive synchronous regulator MOSFET 14 is turned off, diode 16 continues to deliver charge to capacitor 18 until low-side MOSFET 11 is turned-on. Turning on low-side MOSFET 11, not turning off synchronous rectifier MOSFET 14, terminates charging of capacitor 18 and therefore determines its voltage. Similarly whenever negative synchronous regulator MOSFET 14 is turned off, diode 16 continues to deliver charge to capacitor 18 until low-side MOSFET 11 is turned-on.

The maximum voltage conditions in this converter happen when diode conduction is occurring, i.e. when MOSFETs are off. For example, the maximum voltage of the Vₓ node occurs when both low-side and synchronous rectifier MOSFETs 11 and 14 are off. Under such conditions the voltage is determined by the output voltage +V_{OUT1} plus the forward bias voltage V_{f} across the clamp diode, i.e. Vₓ(max)≦(V_{OUT1}+V_{f}). MOSFET 11 needs to be able to block Vₓ(max) in its off state.

Similarly, the maximum negative voltage of the V_{y} node occurs when both high-side and synchronous rectifier MOSFETs 13 and 15 are off. Under such conditions the voltage is determined by the output voltage −V_{OUT2} minus the forward bias voltage −V_{f} across the clamp diode, i.e. V_{y}>(−V_{OUT2}−V_{f}). MOSFET 13 needs to be able to block V_{y} in its off state.

One feature of the disclosed converter 10 is that since the inductor is floating, i.e. not permanently connected to a supply rail, turning on either the high-side or low-side MOSFETs 11 and 13 but not both can force the voltage at V_{y} or Vₓ without magnetizing or increasing the current in inductor 12. This is not possible for a conventional boost converter like the one in FIG. 1 where a single MOSFET both controls the Vx voltage but also causes current conduction, magnetizing the inductor. In other words in a conventional converter, controlling the inductor voltage also causes additional and sometimes unwanted energy storage. In the disclosed converter, either Vₓ or V_{y} can be forced to a supply voltage without magnetizing the inductor.

Another consideration is the output voltage range of conventional boost converter 1. If a P-N diode 5 is present across a synchronous rectifier MOSFET, the minimum output voltage for the boost converter's output is necessarily V_{batt}, because the diode forward biases pulling the output up to V_{batt} as soon as power is applied to the regulator's input terminals. In the disclosed dual output converter, the circuit from V_{batt} to +V_{OUT1} includes two switches with opposite polarity P-N diodes, allowing +V_{OUT1} to regulate a voltage less than V_{batt}, a feature not possible with a conventional boost converter topology.

So while boost converters can only step up voltage, the disclosed converter produces a positive output voltage that can be less than, equal to or greater than the battery voltage, and is therefore not restricted to operation only above V_{batt}. Adapting a boost converter's topology for step-down voltage regulation is the subject of a related patent application by Richard K. Williams entitled “High-Efficiency Up-Down and Related DC/DC Converters” (filed on the same day herewith) and is included herein by reference.

In a related patent application entitled “Dual-Polarity Multi-Output DC/DC Converters and Voltage Regulators” by Richard K. Williams (filed on the same day herewith), the application of a time-multiplexed-inductor in both positive and negative output boost converters is described and is incorporated herein by reference.

Time Multiplexed Dual-Polarity Floating Inductor Regulator; As described previously, the preferred embodiment of this invention is to simultaneously charge both positive and negative outputs and to discontinue charging of which ever output reaches the targeted regulation voltage while continuing to charge the other output.

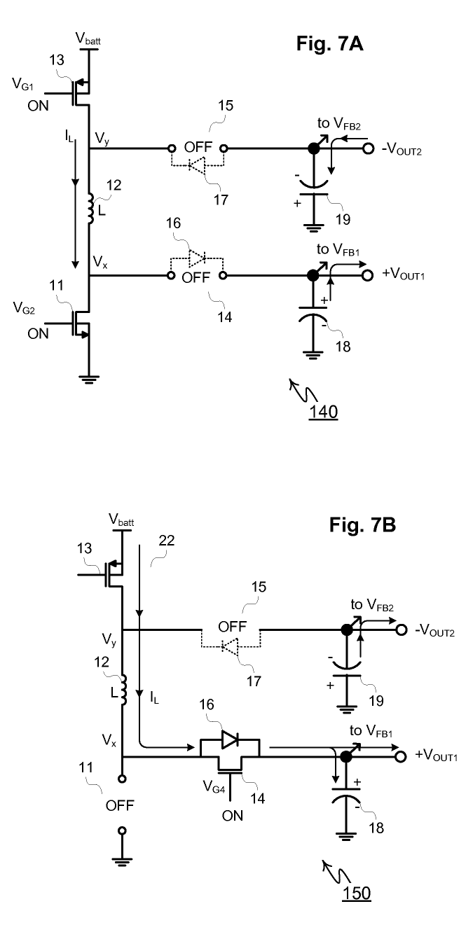

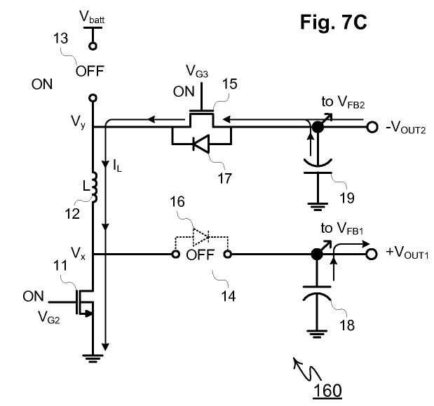

FIG. 7 illustrates an alternative sequence using time multiplexing. In circuit 140 of FIG. 7A, low side and high-side MOSFETs are turned on magnetizing inductor 12. In FIG. 7B, only low-side MOSFET 11 is turned off causing Vₓ to fly up and charge +VOUT1 capacitor 18 till VOUT1 reaches its target value. Synchronous rectifier MOSFET is turned-on in tandem with diode 16 conduction to improve efficiency. Output capacitor q9 is not charged in this cycle.

Once VOUT1 reaches its targeted voltage synchronous rectifier 14 is shut off and low-side MOSFET 11 is turned on forcing Vₓ to ground and discontinuing charging of capacitor 18. At the same time high-side MOSFET 13 is turned off allowing V_{y} to fly negative forward biasing diode 17 and charging negative output −V_{OUT2} capacitor 10. Synchronous rectifier MOSFET 15 is turned on to improve efficiency. Once −V_{OUT2} reaches its regulated voltage target synchronous rectifier 15 is turned off. High-side MOSFET 13 is then turned on and inductor 12 is again magnetized. The cycle then repeats in time-multiplexed sequence. The algorithm for time multiplexing is illustrated in flow chart 180 of FIG. 8.

While this algorithm can be achieved using analog circuitry, an alternative approach uses a digital controller or microprocessor 220 as shown in FIG. 200. The analog feedback from the outputs VFB1 and VFB2, as shown may be multiplexed with MOSFETs 226A and 226B and converted to digital format using a single A/D converter 225. The below ground voltage requires a level shift circuit 227 to convert the voltage to positive potentials.

The positive output of microcontroller 220 as shown can drive MOSFETs 213 and 211 directly but require level shift circuits 223 and 224 to drive floating synchronous rectifier MOSFETs 214 and 215.

What is claimed is:

1. A dual-polarity dual-output synchronous boost converter that comprises:
an inductor;
a first output node;
a second output node; and
a switching network, the switching network configured to provide the following modes of circuit operation:
a first mode where the positive electrode of the inductor is connected to an input voltage and the negative electrode of the inductor is connected to ground;
a second mode where the positive electrode of the inductor is connected to the first output node and the negative electrode of the inductor is connected to the second output node; and
a third mode where the positive electrode of the inductor is connected to the input voltage and the negative electrode of the inductor is connected to the second output node.

2. A dual-polarity dual-output synchronous boost converter as recited in claim 2 that further comprises a control circuit that causes the first, second and third modes to be selected in a repeating sequence.

3. A dual-polarity dual-output synchronous boost converter as recited in claim 3 in which the repeating sequence has the form: first mode, second mode, first mode, third mode.

4. A dual-polarity dual-output synchronous boost converter as recited in claim 3 in which the repeating sequence has the form: first mode, second mode, third mode.

5. A dual-polarity dual-output synchronous boost converter as recited in claim 1 in which the switching network is further configured to provide a fourth mode where the positive electrode of the inductor is connected to the first output node and the negative electrode of the inductor is connected to ground.

6. A dual-polarity dual-output synchronous boost converter as recited in claim 1 that further comprises a feedback circuit that modulates the duration of the second mode to control the voltage of the first output node.

7. A dual-polarity dual-output synchronous boost converter as recited in claim 6 in which the feedback circuit modulates the duration of the third mode to control the voltage of the second output node.

8. A dual-polarity dual-output synchronous boost converter that comprises:
an inductor;
a first output node;
a second output node; and
a switching network, the switching network configured to provide the following modes of circuit operation:
a first mode where the positive electrode of the inductor is connected to an input voltage and the negative electrode of the inductor is connected to ground;
a second mode where the positive electrode of the inductor is connected to the input voltage and the negative electrode of the inductor is connected to the second output node; and
a third mode where the positive electrode of the inductor is connected to the first output node and the negative electrode of the inductor is connected to ground.

9. A dual-polarity dual-output synchronous boost converter as recited in claim 8 that further comprises a control circuit that causes the first, second and third modes to be selected in a repeating sequence.

10. A dual-polarity dual-output synchronous boost converter as recited in claim 9 in which the repeating sequence has the form: first mode, second mode, first mode, third mode.

11. A dual-polarity dual-output synchronous boost converter as recited in claim 9 in which the repeating sequence has the form: first mode, second mode, third mode.

12. A dual-polarity dual-output synchronous boost converter as recited in claim 8 that further comprises a feedback circuit that modulates the duration of the second mode to control the voltage of the first output node.

13. A dual-polarity dual-output synchronous boost converter as recited in claim 8 that further comprises a feedback circuit that modulates the duration of the third mode to control the voltage of the second output node.

14. A method for operating a dual-polarity dual-output synchronous boost converter which includes an inductor, a first output node and a second output node, the method comprising:
configuring a switching network so that the boost converter operates in a first mode where the positive electrode of the inductor is connected to an input voltage and the negative electrode of the inductor is connected to ground;
configuring the switching network so that the boost converter operates in a second mode where the positive electrode of the inductor is connected to the first output node and the negative electrode of the inductor is connected to the second output node; and
configuring the switching network so that the boost converter operates in a third mode where the positive electrode of the inductor is connected to the input voltage and the negative electrode of the inductor is connected to the second output node.

15. A method as recited in claim 14 in which the first, second and third modes are selected in a repeating sequence.

16. A method as recited in claim 15 in which the repeating sequence has the form: first mode, second mode, first mode, third mode.

17. A method as recited in claim 15 in which the repeating sequence has the form: first mode, second mode, third mode.

18. A method as recited in claim 14 that further comprises modulating the duration of the second mode to control the voltage of the first output node.

19. A method as recited in claim 18 that further comprises modulating the duration of the third mode to control the voltage of the second output node.

20. A method for operating a dual-polarity dual-output synchronous boost converter which includes an inductor, a first output node and a second output node, the method comprising:
configuring a switching network so that the boost converter operates in a first mode where the positive electrode of the inductor is connected to an input voltage and the negative electrode of the inductor is connected to ground;
configuring the switching network so that the boost converter operates in a second mode where the positive electrode of the inductor is connected to the input voltage and the negative electrode of the inductor is connected to the second output node; and
configuring the switching network so that the boost converter operates in a third mode where the positive electrode of the inductor is connected to the first output node and the negative electrode of the inductor is connected to ground.

21. A method as recited in claim 20 in which the first, second and third modes are selected in a repeating sequence.

22. A method as recited in claim 21 in which the repeating sequence has the form: first mode, second mode, first mode, third mode.

23. A method as recited in claim 21 in which the repeating sequence has the form: first mode, second mode, third mode.

24. A method as recited in claim 20 that further comprises modulating the duration of the second mode to control the voltage of the first output node.

25. A method as recited in claim 20 that further comprises modulating the duration of the third mode to control the voltage of the second output node.
